(19) United States
(12) Patent Application Publication
(10) Pub. No.: US 2026/0148027 A1
(43) Pub. Date: May 28, 2026

(54) IMAGE FORMING APPARATUS CAPABLE OF CONTROLLING TIMING OF SPREADING OF FONT DATA, PRINTING METHOD, AND NON-TRANSITORY COMPUTER-READABLE RECORDING MEDIUM WITH PRINTING PROGRAM STORED THEREIN

(71) Applicant: KYOCERA Document Solutions Inc., Osaka (JP)

(72) Inventor: Hikaru MIYAJI, Osaka (JP)

(73) Assignee: KYOCERA Document Solutions Inc., Osaka (JP)

(21) Appl. No.: 19/395,683

(22) Filed: Nov. 20, 2025

(30) Foreign Application Priority Data
Nov. 28, 2024 (JP) 2024-207355

(51) Int. Cl. G06K 15/02; G03G 15/00

(52) U.S. Cl. CPC G06K 15/1828; G03G 15/50

(57) ABSTRACT

An image forming apparatus includes a control device. The control device operates as a printer. The printer executes: a font spreading step of spreading font data to a RAM after start of processing for printing; a report creation step of using the font data spread to the RAM in the font spreading step to create a report; a report printing step of printing the report created in the report creation step; and a font deletion step of deleting the font data spread to the RAM in the font spreading step from the RAM, and executes the font deletion step after the report creation step.

### INCORPORATION BY REFERENCE

This application claims priority to Japanese Patent Application No. 2024-207355 filed on Nov. 28, 2024, the entire contents of which are incorporated by reference herein.

### BACKGROUND

The present disclosure relates to image forming apparatuses, printing methods, and non-transitory computer-readable recording media with printing programs stored therein.

As an image forming apparatus, there is known an image forming apparatus in which when a language is selected by a user, font data on the language selected by the user is spread to a RAM (random access memory).

### SUMMARY

A technique improved over the aforementioned technique is proposed as one aspect of the present disclosure.

An image forming apparatus according to an aspect of the present disclosure includes a control device. The control device includes a processor and functions as a printer through the processor executing a control program. The printer executes: a font spreading step of spreading font data to a RAM (random access memory) after start of processing for printing; a report creation step of using the font data spread to the RAM in the font spreading step to create a report; a report printing step of printing the report created in the report creation step; and a font deletion step of deleting the font data spread to the RAM in the font spreading step from the RAM, and executes the font deletion step after the report creation step.

A printing method according to another aspect of the present disclosure includes: a font spreading step of spreading font data to a RAM (random access memory) after start of processing for printing; a report creation step of using the font data spread to the RAM in the font spreading step to create a report; a report printing step of printing the report created in the report creation step; and a font deletion step of deleting the font data spread to the RAM in the font spreading step from the RAM, wherein the font deletion step is executed after the report creation step.

A non-transitory computer-readable recording medium according to still another aspect of the present disclosure stores a printing program. The printing program allows a computer to operate to execute: a font spreading step of spreading font data to a RAM (random access memory) after start of processing for printing; a report creation step of using the font data spread to the RAM in the font spreading step to create a report; a report printing step of printing the report created in the report creation step; and a font deletion step of deleting the font data spread to the RAM in the font spreading step from the RAM, and execute the font deletion step after the report creation step.

### BRIEF DESCRIPTION OF THE DRAWINGS

FIG. 1 is a block diagram of an example of an image forming apparatus according to one embodiment of the present disclosure.

FIG. 2 is a block diagram of an example of a hardware configuration of a control device shown in FIG. 1.

FIG. 3 is a flowchart of an example of an operation of the image forming apparatus shown in FIG. 1 in setting a use language.

FIG. 4 is a view showing an example of a language setting screen displayed in the operation shown in FIG. 3.

FIG. 5 is a flowchart of an example of an operation of the image forming apparatus shown in FIG. 1 in printing a report.

FIG. 6 is a view showing an example of a report printing screen displayed in the operation shown in FIG. 5.

FIG. 7 is a view showing how font data stored in a ROM shown in FIG. 2 is spread to a RAM.

FIG. 8 is a view showing an example of a report created by a report printer shown in FIG. 1.

FIG. 9 is a view showing an example of the RAM shown in FIG. 2 when the font data has been deleted therefrom.

FIG. 10 is a flowchart of an example of the operation of the image forming apparatus in printing a report and different from the example thereof shown in FIG. 5.

### DETAILED DESCRIPTION

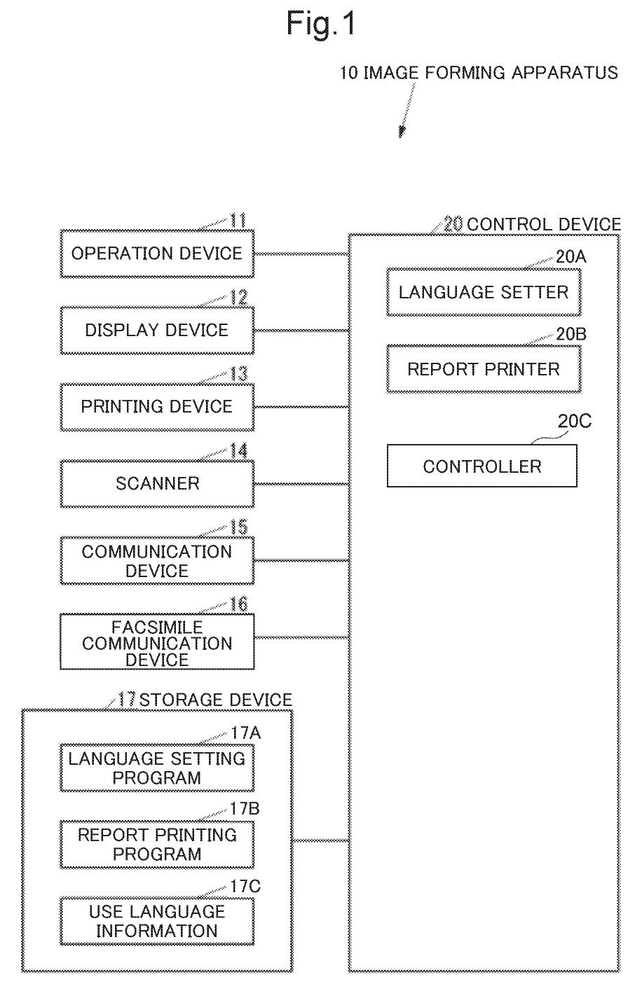

Hereinafter, a description will be given of an image forming apparatus, a printing method, and a non-transitory computer-readable recording medium with a printing program stored therein, each according to one embodiment of the present disclosure, with reference to the drawings. First, a description will be given of the configuration of an image forming apparatus according to one embodiment of the present disclosure. FIG. 1 is a block diagram of an example of an image forming apparatus 10 according to this embodiment.

As shown in FIG. 1, the image forming apparatus 10 includes: an operation device 11 which is an operation device, such as, for example, buttons, through which various operations are to be input; a display device 12 which is a display device, such as an LCD (liquid crystal display), that displays various information; a printing device 13 which is a printing device formed of an electrophotographic printing mechanism that prints an image on a recording medium, such as a sheet of paper; a scanner 14 which is a reading device that reads an image from an original document; a communication device 15 which is a communication device that communicates with external devices via a network, such as a LAN (local area network) or the Internet, or directly by wire or wireless without any network; a facsimile communication device 16 which is a facsimile device that does facsimile communication with unshown external facsimile devices via communication lines, such as public phone lines; a storage device 17 which is a non-volatile storage device, such as a semiconductor memory or an HDD (hard disk drive), that stores various information; and a control device 20.

The storage device 17 stores a language setting program 17A for use in setting a language for use (hereinafter, referred to as a "use language") in the image forming apparatus 10. The language setting program 17A may be installed in the storage device 17, for example, at the production stage of the image forming apparatus 10, installed therein from an external storage medium, such as a USB (universal serial bus) memory, or additionally installed therein via the communication device 16 from a network.

The storage device 17 further stores a report printing program 17B for use in printing a report showing at least either the settings or statuses of the image forming apparatus 10. The report printing program 17B may be installed in the storage device 17, for example, at the production stage of the image forming apparatus 10, installed therein from an external storage medium, such as a USB memory, or additionally installed therein via the communication device 16 from a network.

Examples of the report include: (1) a status page showing various statuses of the image forming apparatus 10, including information on firmware in the image forming apparatus 10, information on optional devices with which the image forming apparatus 10 is equipped, network-related information on the image forming apparatus 10, information on a later-described RAM (random access memory) in the image forming apparatus 10, information on the number of pages printed by the image forming apparatus 10, and the toner level of the printing device 13; (2) a setting information list showing the statues of various settings in the image forming apparatus 10; (3) an address book list showing the contents of an address book stored in the image forming apparatus 10; and (4) a service status showing various statuses of the image forming apparatus 10 described more specifically for service persons than the normal status page.

The storage device 17 stores use language information 17C showing the use language. The use language shown in the use language information 17C is used as a language constituting the texts on various screens displayed on the display device 12 for the user to operate the image forming apparatus 10 (hereinafter, referred to as "operation screens"), used also as a language constituting the texts on various web pages provided by the image forming apparatus 10 for the user to remotely operate the image forming apparatus 10 (hereinafter, referred to as "operation pages"), and used also as a language in the port.

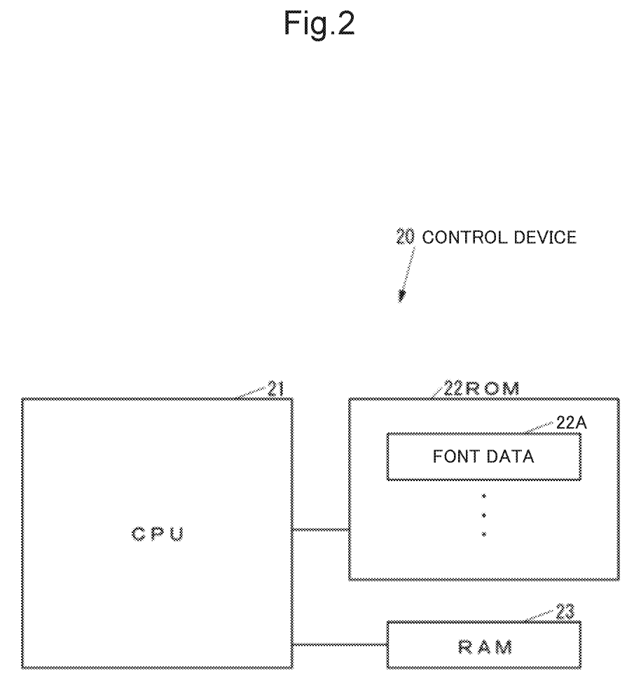

FIG. 2 is a block diagram of an example of a hardware configuration of the control device 20. The control device 20 is constituted by a processor, a RAM (random access memory) 23, a ROM (read only memory) 22, and so on. The processor is an example of the computer and is, for example, a CPU (central processing unit), an MPU (micro processing unit) or an ASIC (application specific integrated circuit). In this embodiment, a description will be given of the case where the processor is a CPU. When the CPU executes a control program stored in the ROM 22 or so on, the control device 20 functions as a controller 20C. The controller 20C governs the overall operation control of the image forming apparatus 10. The ROM 22 stores not only the above control program, but also various data. The RAM 23 is a memory for use as a working area for the CPU 21.

The ROM 22 stores English font data 22A containing alphabet characters as characters. The ROM 22 further stores font data of at least one language different from English. The ROM 22 stores font data for each kind of language. For example, the ROM 22 stores, in addition to the English font data 22A, Japanese font data containing hiragana, katakana, and kanji characters, simplified Chinese font data containing simplified Chinese characters, and traditional Chinese font data containing traditional Chinese characters. These kinds of font data stored in the ROM 22 each consist of a TTF (TrueType font) file.

The above CPU of the control device 20 shown in FIG. 1 executes the language setting program 17A stored in the storage device 17 and, thus, operates as a language setter 20A that sets the use language. Furthermore, the CPU of the control device 20 executes the report printing program 17B (an example of the printing program) stored in the storage device 17 and, thus, operates as a report printer 20B (an example of the printer) that does control for printing a report. As can be seen from the discussion thus far, the control device 20 includes the language setter 20A, the report printer 20B, and the controller 20C. The storage device 17 is an example of the non-transitory computer-readable recording medium. The report printing program 17B may be stored in a non-transitory computer-readable recording medium, such as a CD or a USB memory, and may be installed into the storage device 17 from the recording medium by the controller 20C.

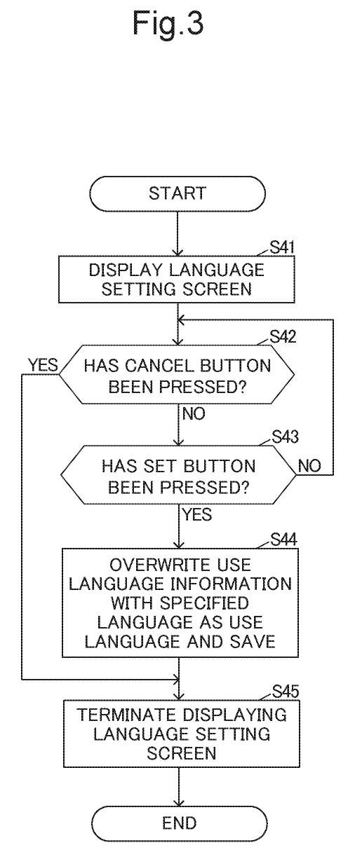

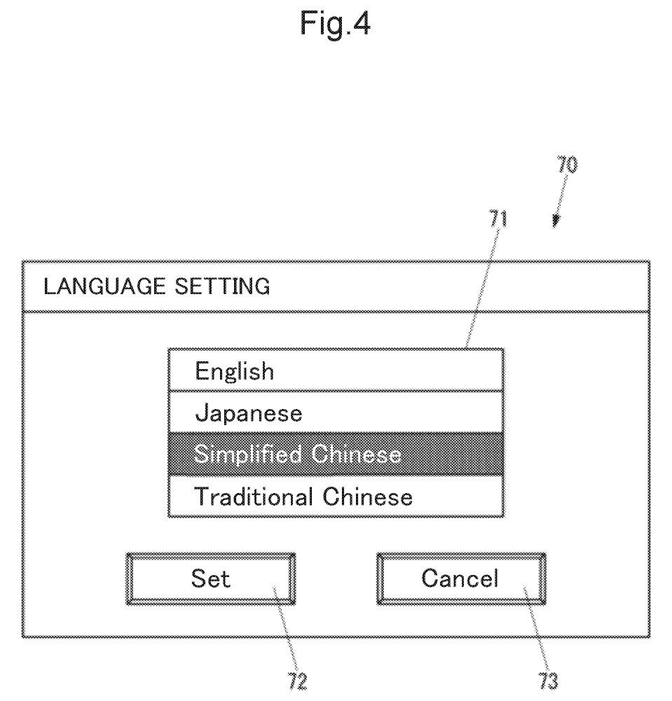

Next, a description will be given of operations of the image forming apparatus 10. First, a description will be given of an operation of the image forming apparatus 10 in setting the use language. FIG. 3 is a flowchart of an example of the operation of the image forming apparatus 10 in setting the use language. FIG. 4 is a view showing an example of a language setting screen.

A start instruction to start processing for setting the use language is accepted by the operation device 11 by an operation made by the user of the image forming apparatus 10. When, in accordance with this start instruction, the language setter 20A of the image forming apparatus 10 is instructed to start the processing for setting the use language, it executes the operation shown in FIG. 3.

The language setter 20A allows the display device 12 to display a screen (hereinafter, referred to as a "language setting screen") 70 (see FIG. 4) for use in accepting an instruction to set the use language (S41).

The language setting screen 70 shown in FIG. 4 contains a list box 71 which is an image showing a list of specifiable languages, a Set button 72 through which a setting instruction to set a language selected from the list shown in the list box 71 is accepted, and a Cancel button 73 through which a cancel instruction to cancel the setting of the use language is accepted.

The display of the list box 71 contains English, Japanese, Simplified Chinese, and Traditional Chinese. When the user makes a touch gesture on a portion of the list box 71 where one of the above languages is displayed, a specification instruction to specify the language displayed on the portion is accepted by the operation device 11 through a touch panel provided on the display device 12. FIG. 4 shows a state where a single language (Simplified Chinese) is specified.

Subsequently, after the processing step S41, the language setter 20A determines whether or not a cancel instruction based on a pressing of the Cancel button 73 has been accepted by the operation device 11 (S42).

When determining that no cancel instruction has been accepted by the operation device 11 (NO in S42), the language setter 20A determines whether or not a setting instruction based on a pressing of the Set button 72 has been accepted by the operation device 11 (S43). When the language setter 20A determines that no setting instruction has been accepted by the operation device 11 (NO in S43), the processing goes back to S42.

When determining that the above setting instruction has been accepted by the operation device 11 (YES in S43), the language setter 20A overwrites the use language information 17C, which is stored in the storage device 17, to allow the use language information 17C to contain as the use language a language indicated by the specification instruction having been accepted by the operation device 11 at the time of acceptance of the setting instruction by the operation device 11, thus saving the overwritten use language information 17C in the storage device 17 (S44).

When the language setter 20A determines that the cancel instruction has been accepted by the operation device 11 (YES in S42) or when the processing step S44 ends, the language setter 20A allows the display device 12 to terminate displaying the language setting screen 70 (S45). Thereafter, the processing shown in FIG. 3 ends.

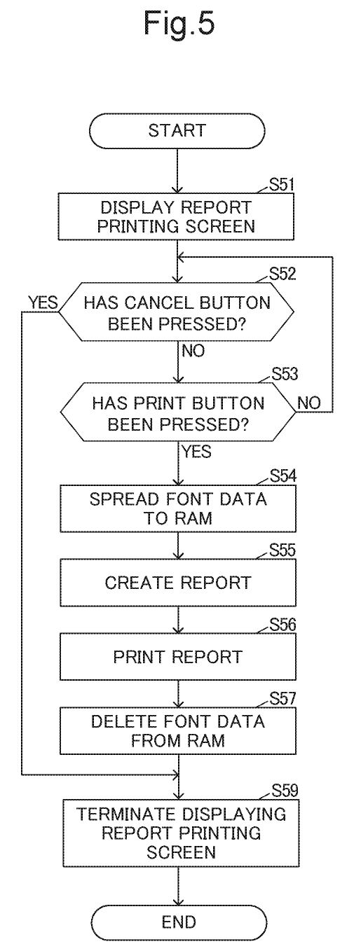

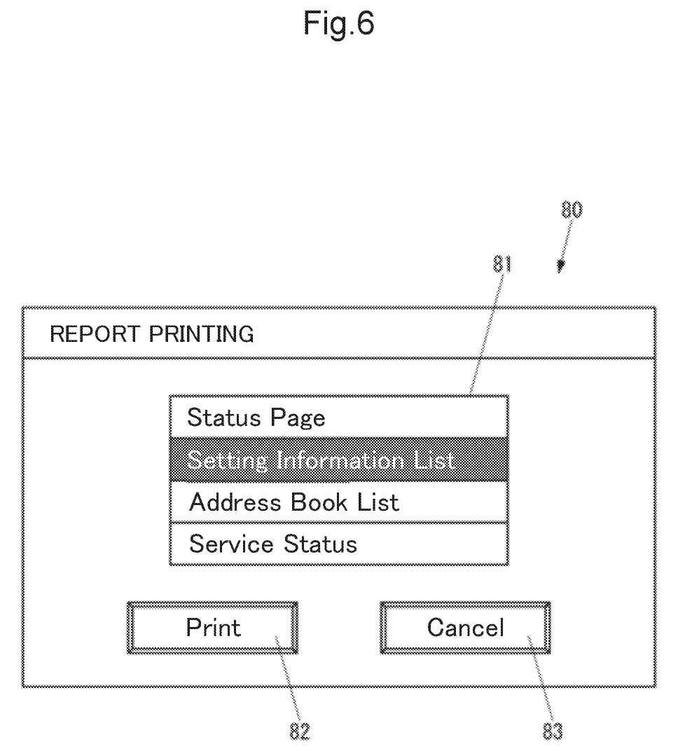

Next, a description will be given of an operation of the image forming apparatus 10 in printing a report. FIG. 5 is a flowchart of an example of the operation of the image forming apparatus 10 in printing a report. FIG. 6 is a view showing an example of a report printing screen.

When a start instruction to start processing for printing a report is accepted by the operation device 11 by an operation made by the user of the image forming apparatus 10, the report printer 20B executes the operation shown in FIG. 5 in accordance with the start instruction.

The report printer 20B allows the display device 12 to display a screen (hereinafter, referred to as a "report printing screen") 80 (see FIG. 6) for use in accepting an instruction to specify a report to be printed (S51).

The report printing screen 80 shown in FIG. 6 contains a list box 81 which is an image showing a list of specifiable reports, a Print button 82 through which a specification instruction to specify a report to be printed from the list shown in the list box 81 is accepted, and a Cancel button 83 through which a cancel instruction to cancel the printing of the report is accepted.

The display of the list box 81 contains Status Page, Setting Information List, Address Book List, and Service Status. When the user makes a touch gesture on a portion of the list box 81 where one of the above reports is displayed, a specification instruction to specify the report displayed on the portion is accepted by the operation device 11 through the touch panel. FIG. 6 shows a state where a single report (Setting Information List) is specified.

Subsequently, after the processing step S51, the report printer 20B determines whether or not a cancel instruction based on a pressing of the Cancel button 83 has been accepted by the operation device 11 (S52).

When determining that a cancel instruction based on a pressing of the Cancel button 83 has not been accepted by the operation device 11 (NO in S52), the report printer 20B determines whether or not a specification instruction based on a pressing of the Print button 82 has been accepted by the operation device 11 (S53). When the report printer 20B determines that no specification instruction has been accepted by the operation device 11 (NO in S53), the processing goes back to S52.

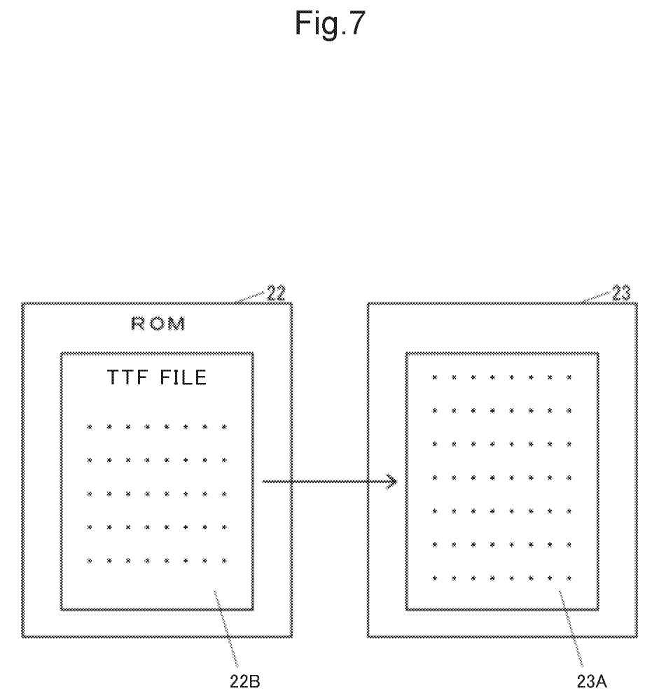

FIG. 7 is a view showing how font data 22B stored in the ROM 22 is spread to the RAM 23.

When determining that the specification instruction has been accepted by the operation device 11 (YES in S53), the report printer 20B spreads, among a plurality of kinds of font data stored in the ROM 22, font data 22B of the use language shown in the use language information 17C to the RAM 23 as font data 23A (S54), as shown as an example in FIG. 7. FIG. 7 shows the font data with the details omitted.

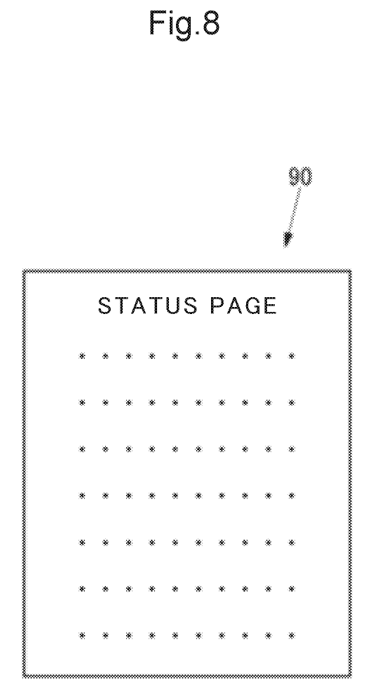

Subsequently, after the processing step S54 ends, the report printer 20B creates a report 90, in the form of image data formed of, for example, raster data using the font data 23A spread to the RAM 23 in S54, to contain the contents shown by the report specified by the specification instruction having been accepted by the operation device 11 at the time of acceptance (S53) of the specification instruction by the operation device 11 (S55), as shown as an example in FIG. 8. FIG. 8 shows the report 90, which is a status page, with the details omitted.

Then, when the processing step S55 ends, the report printer 20B allows the printing device 13 to print the report 90 created in S55 (S56).

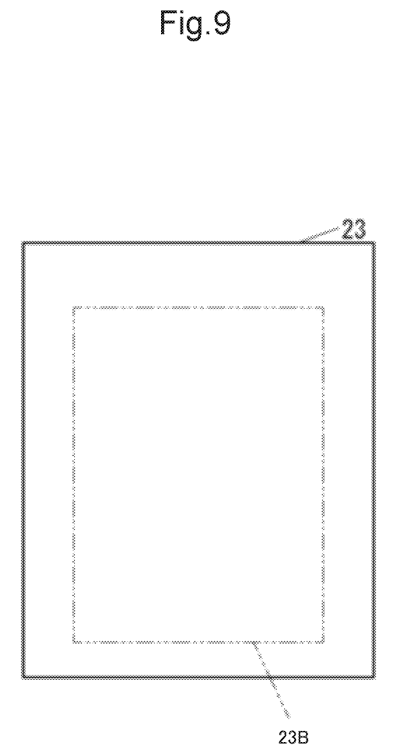

When the processing step S56 ends, the report printer 20B deletes the font data 23A (see FIG. 7) spread to the RAM 23 in S54 from the RAM 23 (S57), as shown as an example in FIG. 9. In other words, the report printer 20B unloads the font data 23A (see FIG. 7) spread to the RAM 23 in S54 from an area 23B (see FIG. 9) of the RAM 23 having been used by the font data 23A.

When the report printer 20B determines that the above cancel instruction has been accepted by the operation device 11 (YES in S52) or when the processing step S57 ends, the report printer 20B allows the display device 12 to terminate displaying the report printing screen 80 (S59). Thereafter, the processing shown in FIG. 5 ends.

The above description has been given of a method for creating a report according to the use language shown in the use language information 17C. As for a method for creating an operation screen according to the use language shown in the use language information 17C and a method for creating an operation page according to the use language shown in the use language information 17C, their description will be omitted herein. However, these methods may be the same as or different from the method for creating a report according to the use language shown in the use language information 17C.

As thus far described, after the start of processing for printing a report, the image forming apparatus 10 spreads font data 22B to the RAM 23 as font data 23A (S54), creates a report 90 using the font data 23A (S55), and then deletes the font data 23A from the RAM 23 (S57). Therefore, the period of time during which the font data 23A is spread to the RAM 23 can be shortened and, as a result, the amount of use (time of use) of the RAM 23 can be reduced.

For example, in a general image forming apparatus not according to this embodiment, font data is always spread to a RAM, which presents a problem of a large amount of use of the RAM. Unlike this, in the above embodiment, the period of time during which font data is spread to the RAM can be made shorter than in the general image forming apparatus and the amount of use (time of use) of the RAM can be reduced as compared to the general image forming apparatus.

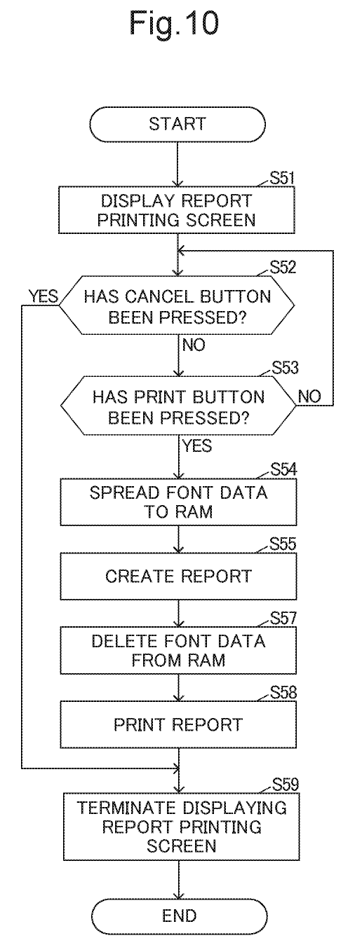

In another embodiment, the image forming apparatus 10 may execute, instead of the operation shown in FIG. 5, an operation shown in FIG. 10. FIG. 10 is a flowchart of an example of the operation of the image forming apparatus 10 in printing a report and different from the example shown in FIG. 5. The description of the same portions of the processing as those of the processing shown in FIG. 5 will be omitted.

In the operation shown in FIG. 5, before the font data 23A (FIG. 7) spread to the RAM 23 in S54 is deleted from the RAM 23 (S57), the report 90 created in S55 is printed by the printing device 13 (S56). On the other hand, the operation shown in FIG. 10 is different from the operation shown in FIG. 5 in that after the font data 23A spread to the RAM 23 in S54 is deleted from the RAM 23 (S57), the report 90 created in S55 is printed by the printing device 13 (S58).

Specifically, in executing, not the operation shown in FIG. 5, but the operation shown in FIG. 10, after creating the report 90 using the font data 23A spread to the RAM 23 (S55) and before printing the report 90 (S58), the report printer 20B of the image forming apparatus 10 deletes the font data 23A from the RAM 23 (S57). Therefore, in the operation shown in FIG. 10, the period of time during which the font data 23A is spread to the RAM 23 can be further shortened as compared to the case of executing the operation shown in FIG. 5 and, as a result, the amount of use of the RAM 23 can be further reduced.

Since the font data 22B used in the image forming apparatus 10 consists of a TTF file, the image forming apparatus 10 can increase convenience. Specifically, the image forming apparatus 10 is sufficient to spread a single set of font data 22B consisting of a TTF file to the RAM 23 and, therefore, the control on the spreading of font data to the RAM 23 can be simplified as compared to the case where all pieces of data of characters necessary to print the report 90 are spread piece by piece to the RAM 23. The image forming apparatus 10 spreads font data 22B, which is a TTF file containing all characters that will normally be used, to the RAM 23. Therefore, even when another kind of characters become newly necessary to print the report 90, the necessity to add character data can be reduced as compared to the case where pieces of data of characters newly necessary to print the report 90 are spread piece by piece to the RAM 23. In addition, since the image forming apparatus 10 spreads font data 22B, which is a TTF file freely changeable in character size and thickness, to the RAM 23, the changes in size and thickness of characters for use in the report 90 can be simplified as compared to the case where all pieces of data of characters necessary to print the report 90 and fixed in size and thickness are spread piece by piece to the RAM 23.

While the present disclosure has been described in detail with reference to the embodiments thereof, it would be apparent to those skilled in the art that the various changes and modifications may be made therein within the scope defined by the appended claims.

What is claimed is:

1. An image forming apparatus comprising a control device that comprises a processor and functions as a printer through the processor executing a control program,
the printer executing:
a font spreading step of spreading font data to a RAM (random access memory) after start of processing for printing;
a report creation step of using the font data spread to the RAM in the font spreading step to create a report;
a report printing step of printing the report created in the report creation step; and
a font deletion step of deleting the font data spread to the RAM in the font spreading step from the RAM, and
executing the font deletion step after the report creation step.

2. The image forming apparatus according to claim 1, wherein the printer executes the font deletion step before the report printing step.

3. The image forming apparatus according to claim 1, wherein
the control device operates as a language setter through the processor executing a control program,
the image forming apparatus further comprises a storage device,
the language setter allows the storage device to store use language information showing a use language specified by a user, and
in the font spreading step, the printer spreads, among a plurality kinds of font data stored in the control device, font data of the language shown in the use language information to the RAM.

4. The image forming apparatus according to claim 1, wherein the font data consists of a TTF (TrueType font) file.

5. A printing method comprising:
a font spreading step of spreading font data to a RAM (random access memory) after start of processing for printing;
a report creation step of using the font data spread to the RAM in the font spreading step to create a report;
a report printing step of printing the report created in the report creation step; and
a font deletion step of deleting the font data spread to the RAM in the font spreading step from the RAM,
wherein the font deletion step is executed after the report creation step.

6. A non-transitory computer-readable recording medium with a printing program stored therein, the printing program allowing a computer to operate to execute:
a font spreading step of spreading font data to a RAM (random access memory) after start of processing for printing;
a report creation step of using the font data spread to the RAM in the font spreading step to create a report;
a report printing step of printing the report created in the report creation step; and
a font deletion step of deleting the font data spread to the RAM in the font spreading step from the RAM, and
execute the font deletion step after the report creation step.
